(19) United States
(12) Patent Application Publication
(10) Pub. No.: US 2024/0101438 A1
(43) Pub. Date: Mar. 28, 2024

(54) RECOVERY OF LITHIUM FROM AQUEOUS SOLUTIONS

(71) Applicant: GALAXY RESOURCES LIMITED, Applecross, Western Australia (AU)

(72) Inventors: Brian Colin TALBOT, Scarborough, Western Australia (AU); Enej CATOVIC, Mt Pleasant, Western Australia (AU)

(21) Appl. No.: 18/250,715

(22) PCT Filed: Oct. 22, 2021
(86) PCT No.: PCT/AU2021/051237

§ 371 Date: Apr. 26, 2023

(30) Foreign Application Priority Data
Oct. 27, 2020 (AU) 2020903897

(51) Int. Cl. C01D 15/08; C01D 15/04; C01F 5/22; C02F 1/52; C22B 3/42; C22B 26/22

(52) U.S. Cl. CPC C01D 15/08; C01D 15/04; C01F 5/22; C02F 1/5245; C22B 3/42; C22B 26/22

(57) ABSTRACT

The present invention relates to a method for the recovery of lithium products from an aqueous solution, the method comprising the steps of: (i.) contacting the solution with an alkaline material to precipitate a target amount of magnesium in the brine solution and separating the precipitated solids from an intermediate solution; (ii.) contacting the intermediate solution with a controlled amount of a hydroxide salt to precipitate magnesium in the intermediate solution; (iii.) contacting the intermediate solution with a controlled amount of sodium carbonate to precipitate impurities and separating the precipitated solids from a purified solution; and (iv.) recovering lithium products from the purified solution.

### TECHNICAL FIELD

The present invention relates to method for the recovery of lithium products from aqueous solutions. More specifically, the method of the present invention allows for the recovery of high purity lithium products. The method of the present invention is particularly suited to the recovery of lithium products from brine solutions.

### BACKGROUND ART

The following discussion of the background art is intended to facilitate an understanding of the present invention only. The discussion is not an acknowledgement or admission that any of the material referred to is or was part of the common general knowledge as at the priority date of the application.

Lithium may be found naturally occurring in brine solutions that originate from salt lakes or ground water sources. These solutions typically contain a relatively low amount of dissolved lithium cations compared to sodium chloride. These solutions also contain other dissolved impurity species, such as potassium, magnesium, calcium, chlorides, sulphates and borates. The lithium concentration in these solutions is typically increased by storing the solutions in evaporation ponds for an extended period time in order to increase the lithium concentration. The evaporation process will lead to the precipitation of some of the impurities as salts, allowing for separation. The concentrated brine solutions are then treated to remove remaining impurities and to recover lithium. The processing of concentrated brine solutions differs depending on the impurities present in the concentrated brine solution.

Lithium is then recovered from the solution through the addition of sodium carbonate (soda ash) to precipitate lithium carbonate. Whilst the process is relatively simple, unless impurities are removed prior to the addition of sodium carbonate, the lithium carbonate product that is precipitated is not high purity. The most problematic impurity is magnesium which has very similar chemical properties to lithium. If magnesium is present in the solution during the precipitation of lithium carbonate it will typically co-precipitate as MgCO₃. The recovered product must then be subjected to further purification processes to remove the impurities.

The most common approach to remove magnesium from the brine solution is through the addition of lime Ca(OH)₂ to increase the solution pH and precipitate magnesium hydroxide, allowing for subsequent separation by filtration. The main disadvantage of process is the significant amount of lime that is required to increase the pH of the solution, which has a large aqueous component. Furthermore, the use of lime introduces calcium into the solution and this calcium must be removed prior to lithium recovery.

A number of other technologies have been proposed to recover lithium from brines. These technologies typically focus on the selective absorption of lithium from the brine sources. Lithium selective ion exchange resins based on alumina compounds demonstrate high lithium absorption but require the subsequent acid treatment to strip the lithium followed by treatment to regenerate the resins. Electrochemistry methods have also been proposed to separate lithium from the brine solutions, but these require significant energy input. Nano-filtration membranes have also been shown to selectively recover lithium, but there are challenges associated with operating these at industrial scale.

The main problem faced with the processing of brine solutions is the low concentration of lithium. This requires large volumes of the brine to be processed, which leads to difficulties scaling the processes used.

Throughout this specification, unless the context requires otherwise, the word “comprise” or variations such as “comprises” or “comprising”, will be understood to imply the inclusion of a stated integer or group of integers but not the exclusion of any other integer or group of integers.

### SUMMARY OF INVENTION

In accordance with the present invention, there is provided a method for the recovery of lithium products from an aqueous solution, the method comprising the steps of:
i. contacting the aqueous solution with an alkaline material to precipitate a target amount of magnesium in the aqueous solution and separating the precipitated solids from an intermediate solution;
ii. contacting the intermediate solution with a controlled amount of a hydroxide salt to precipitate magnesium in the intermediate solution;
iii. contacting the intermediate solution with a controlled amount of sodium carbonate to precipitate impurities and separating the precipitated solids from a purified solution; and
iv. recovering lithium products from the purified solution.

The inventors of the present invention have found that the use of separate stages to precipitate out impurities allows for greater control of the additional cations introduced to the solution to remove impurities. This has been found to limit the amount of downstream processing that must be performed to subsequently remove these cations from the solution. In particular, the inventors have found that controlling the amount of the alkaline material introduced in step (i) will limit the alkali cations that will subsequently need to be removed from the system. This has been found particularly useful when calcium hydroxide is used as the alkaline solution as the addition of calcium cations to the system is controlled. Whilst limiting the amount of calcium hydroxide used in step (i) reduces the amount of impurities that are precipitated in this step, the inventors have found that this reduces the amount sodium carbonate that is required in step (iii). This has been found to reduce the proportion of lithium that precipitates as lithium carbonate in this step, thereby increasing the amount of lithium recovered.

The method of the present invention has been found to be particularly useful for the recovery of lithium products from brine solutions. Throughout this specification, the term “brine solution” will be understood to refer to an aqueous solution comprising alkali and/or alkaline earth metal salt(s), wherein the concentration of salts can vary from trace amounts up to the point of saturation. It will be appreciated that brine solutions may be obtained from natural sources or may be generated by industrial processing. As would be appreciated by a person skilled in the art, such solutions typically contain a range of impurities. The method of the present invention seeks to economically remove a number of these impurities in order to allow for high purity lithium products to be recovered directly from the solution.

The method of the present invention is particularly suited to the recovery of lithium from brine solutions that contain less than 6% lithium.

In one form of the present invention, the aqueous solution is subjected to a concentration step prior to step (i). Preferably, the concentration step is an evaporation step.

In one form of the present invention, the concentration step will increase the concentration of lithium in the aqueous solution to 0.1-1.2%. Preferably, the maximum concentration of lithium is 0.7%.

In one form of the present invention, the aqueous solution is treated to reduce the concentration of sulphates.

In one form of the present invention, the concentration of sulphates in the aqueous solution is maintained below 4%. In one form of the present invention, concentration of sulphates in the aqueous solution is maintained through the addition of a precipitating agent. Preferably, the precipitating agent is CaCl₂. More preferably, the CaCl₂ is recycled from other parts of the process.

In one form of the present invention, the alkaline material comprises calcium. Preferably, the alkaline material comprises calcium hydroxide.

In one form of the present invention, the alkaline material is lime. Preferably, the alkaline material is slaked lime.

In one form of the present invention, step (i) precipitates a target amount of the magnesium in the aqueous solution. Preferably, 50-80% of the magnesium in the aqueous solution is precipitated.

In one form of the present invention, step (i) precipitates a target amount of the boron in the aqueous solution. Preferably, 63-83% of the boron in the aqueous solution is precipitated.

In one form of the present invention, the aqueous solution is maintained at a pH of 9 or below during step (i).

In one form of the present invention, the intermediate solution is directed to a secondary concentration step prior to step (ii). Preferably, the secondary concentration is an evaporation step.

In one form of the present invention, the secondary concentration step will increase the concentration of lithium in the aqueous solution to at least 1.2%. Preferably, the concentration of lithium is 1.2%-2.2%. More preferably, the concentration of lithium is 1.2%-1.6%.

In an alternative form of the present invention, the secondary concentration step will increase the concentration of lithium in the aqueous solution to at least 1.6%. Preferably, the concentration of lithium is 1.6%-6.0%. More preferably, the concentration of lithium is 1.6%-4.5%.

In one form of the present invention, the hydroxide salt is sodium hydroxide.

In one form of the present invention, the amount of hydroxide salt added in step (ii) is related to the Mg²⁺ concentration of the intermediate solution. Preferably, a 1.25:1-1:1.25 stoichiometric concentration of Mg²⁺:OH⁻ is targeted. Preferably, where sodium hydroxide is used, a 1.25:1-1:1.25 stoichiometric concentration of Mg²⁺:NaOH is targeted.

In one form of the present invention, the solution pH is maintained below 10 during the step of contacting the intermediate solution with a controlled amount of a hydroxide salt to precipitate magnesium in the intermediate solution

In one form of the present invention, the amount of sodium carbonate added in step (iii) is related to the Ca²⁺ concentration of the intermediate solution. Preferably, a 1.25:1-1:1.25 stoichiometric concentration of Ca²⁺:Na₂CO₃ is targeted.

In embodiments of the present invention where the secondary concentration step targets a concentration of lithium in the aqueous solution of at least 1.6%, the method preferably further comprises subjecting the purified solution to a dilution step prior to the step of recovering lithium products from the purified solution. Preferably, the dilution step comprises the addition of water to the purified solution to reduce the lithium concentration in the purified solution.

In one form of the present invention, lithium carbonate is recovered from the purified solution. Preferably, a controlled amount of sodium carbonate is added to the purified solution to precipitate lithium carbonate. In one form of the present invention, the amount of sodium carbonate added to the purified solution is related to the Li′ concentration of the intermediate solution. Preferably, a 1.25:1-1:1.25 stoichiometric concentration of Li²⁺:Na₂CO₃ is targeted.

In one form of the present invention, lithium carbonate is converted to lithium hydroxide.

In one form of the present invention, lithium hydroxide is recovered from the purified solution.

In one form of the present invention, the recovered lithium product is subjected to a purification step. Preferably, the purification step comprises a hot repulp washing stage. Additionally or alternatively, the purification step comprises a lithium carbonate dissolution step, followed by a lithium carbonate recrystallisation step.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 depicts a flowsheet of a method for the recovery of lithium products from aqueous solutions in accordance with a first embodiment of the present invention;

FIG. 2 depicts a flowsheet of a method for the recovery of lithium products from aqueous solutions in accordance with a second embodiment of the present invention;

FIG. 3 is a plot of the concentration paths for lithium in the test performed in Example 1;

FIG. 4 is a plot of the concentration paths for sulphate in the test performed in Example 1;

FIG. 5 is a plot of the concentration paths for lithium in the second test performed in Example 1;

FIG. 6 is a plot of the concentration paths for sulphate in the second test performed in Example 1;

FIG. 7 Is a plot of the concentration paths for lithium in the test performed in Example 2;

FIG. 8 Is a plot of the concentration paths for sulphate in the test performed in Example 2;

FIG. 9 is a plot of the impurity removal test conducted in Example 3;

FIG. 10 is a plot of the impurity removal test conducted in Example 3 with reference to pH;

FIG. 11 is a plot showing total divalent impurities removed during the test of Example 3; and

FIG. 12 is plot of the removal of magnesium and boron versus pH observed with lime addition for the test conducted in Example 4.

### DESCRIPTION OF EMBODIMENTS

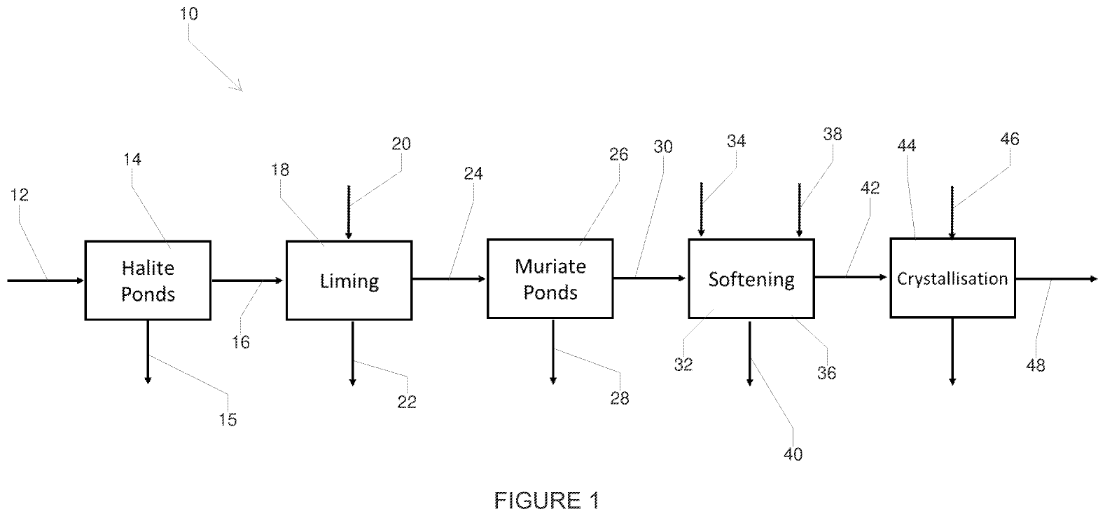

The present invention relates broadly to a method for the recovery of lithium products from an aqueous solution. Whilst the method of the present invention may be used to recover lithium from a range of aqueous solutions, the method of the present invention is particularly suited to recovery of lithium from brine solutions. In FIG. 1, there is shown a method 10 for the recovery of lithium products from a brine solution 12 in accordance with an embodiment of the present invention.

In one embodiment, the brine solution contains less than 6% lithium. In one embodiment, the brine solution contains less than 5% lithium. In one embodiment, the brine solution contains less than 4% lithium. In one embodiment, the brine solution contains less than 3% lithium. In one embodiment, the brine solution contains less than 2% lithium. In one embodiment, the brine solution contains less than 1% lithium. In one embodiment, the brine solution contains less than 0.9% lithium. In one embodiment, the brine solution contains less than 0.8% lithium. In one embodiment, the brine solution contains less than 0.7% lithium. In one embodiment, the brine solution contains less than 0.6% lithium. In one embodiment, the brine solution contains less than 0.5% lithium. In one embodiment, the brine solution contains less than 0.4% lithium. In one embodiment, the brine solution contains less than 0.3% lithium. In one embodiment, the brine solution contains less than 0.2% lithium. In one embodiment, the brine solution contains less than 0.1% lithium.

The brine solution 12 is passed to a concentration step 14 in order to increase the lithium concentration. In the embodiment shown in FIG. 1, the concentration step 14 comprises a solar evaporation process in which the brine solution 12 is directed to an evaporation pond or pan to reduce the water content. It is envisaged that other means for concentrating the brine solution known to those in the art may also be employed. As the brine solution is concentrated several solids will precipitate. The dominant precipitate is halite (NaCl). It is envisaged that the precipitation step may not be required if there is sufficient lithium in the brine solution.

The concentration step is continued until a desired lithium concentration is achieved. In one embodiment, the concentration step will increase the concentration of lithium in the aqueous solution to 0.1-1.2%. In one embodiment, the concentration step will increase the concentration of lithium in the aqueous solution to 0.2-1.2%. In one embodiment, the concentration step will increase the concentration of lithium in the aqueous solution to 0.3-1.2%. In one embodiment, the concentration step will increase the concentration of lithium in the aqueous solution to 0.4-1.2%. In one embodiment, the concentration step will increase the concentration of lithium in the aqueous solution to 0.5-1.2%. In one embodiment, the concentration step will increase the concentration of lithium in the aqueous solution to 0.6-1.2%.

In one embodiment, the maximum concentration of Li in the brine solution is 1.0%. In one embodiment, the maximum concentration of Li in the brine solution is 0.9%. In one embodiment, the maximum concentration of Li in the brine solution is 0.8%. In one embodiment, the maximum concentration of Li in the brine solution is 0.7%.

In one embodiment, the concentration step is conducted until a maximum sulphate concentration is achieved. In one embodiment, the maximum sulphate concentration is 4%. It is envisaged that the concentration of lithium and/or sulphates in the aqueous solution may be monitored using known techniques in the art, for example through inductively coupled plasma mass spectrometry (ICP-MS) techniques.

The inventors have identified that as the brine solution is concentrated, the increase in the lithium concentration will lead to precipitation of KLiSO₄. The lithium concentration at which KLiSO₄ starts to precipitate is dependent on temperature and the concentration of Ca²⁺ and SO₄²⁻ in the brine solution. The inventors have found that by limiting the concentration of lithium and sulphate in the brine solution, the precipitation of KLiSO₄ is significantly reduced. This prevents the loss of lithium in the concentration step 14. It is envisaged that where there is a higher proportion of SO₄²⁻ to Li²⁺ in the system, that a source of Ca²⁺, such as recycled CaCl₂ solution may be introduced to favourably precipitate CaSO₄ over KLiSO₄.

The concentrated solution is recovered and filtered to remove any entrained solids 15.

The filtered brine solution 16 is directed to preliminary impurity removal step 18 to precipitate a target amount of magnesium in the brine solution. To precipitate magnesium, an alkaline material 20 is added to the brine solution. In the preliminary impurity removal step 18 shown in FIG. 1, the brine solution is contacted with slaked lime, Ca(OH)₂, to precipitate a target amount of magnesium in the brine solution. The addition of slaked lime will lead to the precipitation of magnesium hydroxide along with some gypsum CaSO₄·2H₂O. If boron is present in the brine solution, the addition of lime will also lead to the precipitation of boron as borate salts.

Slaked lime is added to precipitate a target amount of the magnesium contained in the brine solution. The inventors have found that by limiting the amount of magnesium that is precipitated, the amount of Ca²⁺ ions that are introduced into the brine solution are also limited. This will in turn reduce the amount of calcium that must be subsequently removed from the solution prior to lithium recovery. Without wishing to be limited by theory, the inventors have found that lithium will be lost during the calcium removal process. By limiting the amount of calcium that is removed, the losses of lithium are also limited.

In one embodiment, 50-80% of the magnesium in the aqueous solution is precipitated. In one embodiment 55-75% of the magnesium in the aqueous solution is precipitated. In one embodiment 70% of the magnesium in the aqueous solution is precipitated.

In one embodiment, 63-83% of the boron in the aqueous solution in precipitated. In one embodiment, 68-78% of the boron in the aqueous solution in precipitated. In one embodiment, 73% of the boron in the aqueous solution in precipitated.

In order to control the amount of magnesium that is precipitated, the addition of calcium hydroxide is based on the concentration of total magnesium in the brine solution. It is envisaged that titrimetric analysis may be used to monitor magnesium in the brine solution. In a preferred embodiment, an online titrator unit is used to monitor and control magnesium concentration following the addition of calcium hydroxide. To ensure excess calcium hydroxide is not added, temperature and mass flow controls are preferably implemented.

In one embodiment, the pH of the solution is maintained below 9.0. Without wishing to be bound by theory, the inventors have found that precipitated boron salts react with lime above pH 9.0 resulting in increased consumption of lime, re-dissolution of boron and introduction of calcium to the brine solution. The inventors have found that at lower temperatures, the pH of the solution may be increased above 9.

Following the addition of slaked lime, the resulting slurry is passed to a solid/liquid separation step to remove solids 22 and produce an intermediate solution 24. In a preferred embodiment, the solid/liquid separation step comprises a thickening step (not shown). The thickener underflow it directed to a filtration step (not shown). The filtrate is combined with the overflow stream and the recovered solids are directed to disposal.

The intermediate solution 24 is directed to a secondary concentration step 26 to increase the lithium concentration. In the embodiment shown in FIG. 1, the concentration step comprises a solar evaporation process in which the intermediate solution 24 is directed to an evaporation pond or pan to reduce the water content. It is envisaged that other means for concentrating the brine solution known to those in the art may also be employed. As the brine solution is concentrated a number of solids will precipitate. The dominant precipitants are halite (NaCl) and potassium chloride (KCl).

The concentration step is continued to a target lithium concentration. In a preferred embodiment, the target concentration of Li is at least 1.2%.

In one embodiment, the secondary concentration step 26 will increase the concentration of lithium in the aqueous solution to at least 1.3%. In one embodiment, the secondary concentration step will increase the concentration of lithium in the aqueous solution to at least 1.4%. In one embodiment, the secondary concentration step will increase the concentration of lithium in the aqueous solution to at least 1.5%.

In one embodiment, the secondary concentration step will increase the concentration of lithium in the aqueous solution to 1.2%-2.2%. In one embodiment, the secondary concentration step will increase the concentration of lithium in the aqueous solution to 1.2%-1.6%.

The concentrated solution is recovered and filtered to remove any entrained solids 28 from the filtered solution 30.

The filtered solution is directed to a primary precipitation step 32 in which it is contacted with a hydroxide salt, for example sodium hydroxide 34 to precipitate the remaining magnesium in the solution as Mg(OH)₂. The addition of sodium hydroxide 34 is based on the concentration of magnesium in the solution. The amount of sodium hydroxide 34 added should target a 1.25:1-1:1.25 stoichiometric relationship between Mg²⁺ and NaOH. It is envisaged that titrimetric analysis may be used to monitor magnesium in the intermediate solution 24. In a preferred embodiment, an online titrator unit is used to monitor and control magnesium concentration following the addition of sodium hydroxide 34. Whilst it is envisaged that other hydroxide salts may equally be used to precipitate Mg(OH)₂, the inventors have found the use of NaOH is preferable as sodium cations are already present in the system

As would be appreciated by a person skilled in the art, the addition of sodium hydroxide 34 will lead to an increase in the solution pH. The inventors have found that an increased pH will lead to lithium losses. By limiting the addition of sodium hydroxide 34, the pH is also limited. In one embodiment, the solution pH in the primary precipitation step 32 is maintained below 10. In one embodiment, the solution pH in the primary precipitation step 32 is maintained below 9.5. In one embodiment, the solution pH in the primary precipitation step 32 is maintained below 9.

Once the pH has been stabilized, a secondary precipitation step 36 is conducted. Whilst not essential, it is envisaged that precipitated species may be removed between the primary precipitation step 32 and the secondary precipitation step 36. In the secondary precipitation step 36, the solution is contacted with sodium carbonate 38 to precipitate calcium carbonate. Sodium carbonate 38 is dosed based on the concentration of Ca²⁺ in solution. The amount of sodium carbonate 38 added should target a 1.25:1-1:1.25 stoichiometric relationship between Ca²⁺ and NaCO₃. It is envisaged that titrimetric analysis may be used to monitor calcium in the intermediate solution 24. In a preferred embodiment, an online titrator unit is used to monitor and control calcium concentration following the addition of sodium hydroxide 34.

In one embodiment, the solution pH is maintained below 10. In one embodiment the solution pH is maintained below 9.5. The inventors have found that lithium carbonate precipitation is correlated to the solution pH. It is understood that by maintaining the solution pH below 10, the precipitation of lithium carbonate can be limited.

The use of sodium carbonate 38 to precipitate calcium carbonate has been shown to also co-precipitate lithium carbonate, which ultimately limits the lithium recovery. The inventors of the present invention have found that by managing the concentration of divalent cations present in the intermediate solution 24, the amount of sodium carbonate 38 required in the secondary precipitation step 36 may be reduced. The two main sources of divalent cations are Mg2+ and Ca²⁺. Whilst the use of Ca(OH)₂ in the preliminary impurity removal step 18 will precipitate and remove Mg²⁺ from the brine solution, it also introduces Ca²⁺ into the brine solution. The inventors have found that by controlling the amount of Mg²⁺ that is precipitated in the preliminary precipitation step, the total divalent cation load in the intermediate solution 24 can be managed. This is achieved by dosing Ca(OH)₂ based on Mg²⁺ concentration in the brine solution. Whilst prior art processes have used Ca(OH)₂ to precipitate magnesium from brine solutions, the Ca(OH)₂ dosage is typically based on achieving a target solution pH to precipitate the maximum possible Mg²⁺. This introduces a significant amount of Ca²⁺ cations, which must then be removed with sodium carbonate 38.

To account for the remaining Mg²⁺ and Ca²⁺ in intermediate solution 24, a two stage precipitation process is used to first remove Mg₂₊ followed by Ca₂₊. By managing the Ca²⁺ introduced in the preliminary impurity removal step 18, the inventors have found that less sodium carbonate 38 is required in the secondary precipitation step 36. This limits the amount of lithium carbonate that is co-precipitated in this secondary precipitation step 36. A further advantage is that the solution pH is maintained below 10, thereby further limiting lithium carbonate precipitation.

The addition of sodium hydroxide 34 and sodium carbonate 38 both dilute the lithium content in the brine solution. As would be appreciated by a person skilled in the art, minimising the dilution is key in obtaining a high purity lithium product from the solution. The inventors have found that lithium in solution should be maintained above 1.1 wt % following the impurity removal steps. Without wishing to be bound by theory, the inventors understand that without sufficient lithium in the solution to precipitate as a carbonate, other impurities will precipitate. This will lead to the impurities in the lithium product.

Following the secondary precipitation step 36, the resulting slurry is passed to a solid/liquid separation step to remove produced solid stream 40 and a purified solution 42 is obtained. In a preferred embodiment, the solid/liquid separation step comprises a thickening step. The thickener underflow it directed to a filtration step. The filtrate is combined with the overflow stream and the recovered solids 40 are directed to disposal.

The purified solution 42 is passed to lithium recovery step 44. In the embodiment shown in FIG. 1, the lithium recovery step 44 comprises the crystallisation of lithium carbonate. To crystallise lithium carbonate, the purified solution 42 is heated to between 80-85° C. The purified solution 42 is then contacted with sodium carbonate 46 to precipitate lithium carbonate.

In a preferred embodiment of the present invention, the dosage of sodium carbonate 46 is based on the concentration of Li+ in the purified solution 42. In one embodiment, sodium carbonate 46 is added to the solution to target a 1.25:1-1:1.25 stoichiometric relationship between Li⁺ and Na₂CO₃.

The resulting slurry is then passed to a solid/liquid separation step in order to recover lithium carbonate 48. The recovered product is washed to reduce the occlusion of impurities such as NaCl and KCl.

The washed product is then passed to a purification step (not shown) to further reduce occluded impurities. In the embodiment shown in FIG. 1, the washed product is redissolved. Lithium carbonate is then recrystallized and the recovered solids are washed to produce high purity lithium carbonate. It is envisaged that alternative means for purification may also be employed. In one embodiment, the lithium product may be subjected to a hot repulp washing step. It is understood by the inventors that at temperatures above approximately 80° C. solid impurities will dissolve, leaving solid lithium products.

Whilst the embodiment shown in FIG. 1 is directed towards the recovery of lithium carbonate as a lithium product, it is envisaged that other lithium products may be recovered. In one embodiment, the lithium carbonate is treated further to produce lithium hydroxide. In an alternative embodiment lithium hydroxide is recovered directly from the purified solution 42.

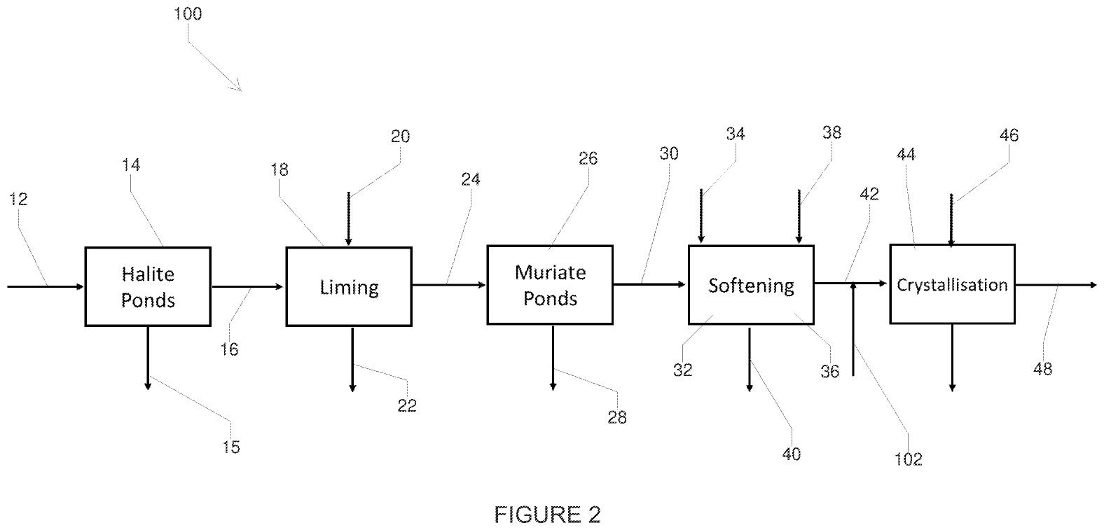

In FIG. 2, there is shown a method for the recovery of lithium products from a brine solution in accordance with an alternative embodiment of the present invention. The embodiment shown in FIG. 2 shares many similarities with the embodiment shown in FIG. 1 and like numerals denote like parts.

The brine solution 12 is passed to a concentration step 14 in order to increase the lithium concentration. In the embodiment shown in FIG. 2, the concentration step 14 comprises a solar evaporation process in which the brine solution is directed to an evaporation pond or pan to reduce the water content. It is envisaged that other means for concentrating the brine solution known to those in the art may also be employed. As the brine solution is concentrated a number of solids will precipitate. The dominant precipitate is halite (NaCl).

The concentration step 14 is continued until a desired lithium concentration is achieved. The preferred lithium concentration and methods for measuring the lithium concentration are similar to those discussed above in respect of FIG. 1.

The concentrated solution is recovered and filtered to remove any entrained solids 15.

The filtered brine solution 16 is directed to preliminary impurity removal step 18 to precipitate an amount of magnesium in the brine solution. In order to precipitate magnesium, an alkaline material 20 is added to the brine solution. In the preliminary impurity removal step 18 shown in FIG. 2, the brine solution is contacted with slaked lime Ca(OH)₂ to precipitate a target amount of magnesium in the brine solution. The addition of slaked lime will lead to the precipitation of magnesium hydroxide along with some gypsum CaSO₄·2H₂O. If boron is present in the brine solution, the addition of lime will also lead to the precipitation of boron as borate salts.

In one embodiment, 50-80% of the magnesium in the aqueous solution is precipitated. In one embodiment 55-75% of the magnesium in the aqueous solution is precipitated. In one embodiment 70% of the magnesium in the aqueous solution is precipitated.

In one embodiment, 63-83% of the boron in the aqueous solution in precipitated. In one embodiment, 68-78% of the boron in the aqueous solution in precipitated. In one embodiment, 73% of the boron in the aqueous solution in precipitated.

Similar methods of controlling the magnesium as discussed above in respect of FIG. 1 similarly apply to the 18 of FIG. 2.

Following the addition of slaked lime, the resulting slurry is passed to a solid/liquid separation step to remove solids and produce an intermediate solution 24. In a preferred embodiment, the solid/liquid separation step comprises a thickening step. The thickener underflow it directed to a filtration step. The filtrate is combined with the overflow stream and the recovered solids are directed to disposal.

The intermediate stream is directed to a secondary concentration step 26 in order to increase the lithium concentration. In the embodiment shown in FIG. 2, the secondary concentration step 26 comprises a solar evaporation process in which the intermediate solution 24 is directed to an evaporation pond or pan to reduce the water content. It is envisaged that other means for concentrating the brine solution known to those in the art may also be employed. As the brine solution is concentrated a number of solids will precipitate. The dominant precipitants are halite (NaCl) and potassium chloride (KCl).

The concentration step is continued to a target lithium concentration. In the embodiment of FIG. 2, the target concentration of Li is increased to the range of 1.6%-6%.

In the embodiment shown in FIG. 2, the concentration step will increase the lithium concentration in the intermediate solution 24 above that of the embodiment discussed above with respect to FIG. 1. The inventors have found that by increasing the lithium concentration in the intermediate stage that a higher purity lithium product may be subsequently recovered. The inventors have found that the increased concentration of the intermediate solution 24 will increase the ratio of lithium to the other impurities in the intermediate solution 24. Without wishing to be bound by theory, it is understood that impurities, such as potassium and sodium, have a lower solubility limit than lithium and so they will reach saturation before lithium. Once the impurities have reached saturation, further concentration of the intermediate solution 24 will only result in the precipitation of impurity solids This will limit the concentration of such species in the intermediate solution 24, whilst allowing the lithium concentration to further increase. The ratio of lithium to impurities in the solution is therefore increased. The inventors have found that this increase in ratio of lithium to impurities may be exploited to reduce the impurities in the final lithium product recovered.

The concentrated solution is recovered and filtered to remove any entrained solids.

The filtered solution is directed to a primary precipitation step 32 in which it is contacted with sodium hydroxide 34 to precipitate the remaining magnesium in the solution as Mg(OH)₂. The addition of sodium hydroxide 34 is based on the concentration of magnesium in the solution. The amount of sodium hydroxide 34 added should target a 1.25:1-1:1.25 stoichiometric relationship between Mg²⁺ and NaOH. It is envisaged that titrimetric analysis may be used to monitor magnesium in the intermediate solution 24. In a preferred embodiment, an online titrator unit is used to monitor and control magnesium concentration following the addition of sodium hydroxide 34.

As would be appreciated by a person skilled in the art, the addition of NaOH will lead to an increase in the solution pH. The inventors have found that an increased pH will lead to lithium losses. By limiting the addition of NaOH, the pH is also limited. In one embodiment, the solution pH in the primary precipitation step 32 is maintained below 10. In one embodiment, the solution pH in the primary precipitation step 32 is maintained below 9.5. In one embodiment, the solution pH in the primary precipitation step 32 is maintained below 9.

Once the pH has been stabilized, a secondary precipitation step 36 is conducted. In the secondary precipitation step 36, the solution is contacted with sodium carbonate 38 to precipitate calcium carbonate. Sodium carbonate 38 is dosed based on the concentration of Ca²⁺ in solution. The amount of sodium carbonate 38 added should target a 1:1 stoichiometric relationship between Ca²⁺ and NaCO₃. It is envisaged that titrimetric analysis may be used to monitor calcium in the intermediate solution 24. In a preferred embodiment, an online titrator unit is used to monitor and control calcium concentration following the addition of sodium hydroxide 34.

In one embodiment, the solution pH is maintained below 10. In one embodiment the solution pH is maintained below 9.5. The inventors have found that lithium carbonate precipitation is correlated to the solution pH. It is understood that by maintaining the solution pH below 10, the precipitation of lithium carbonate can be limited.

Following the secondary precipitation step 36, the resulting slurry is passed to a solid/liquid separation step to remove produced solid stream 40 and a purified solution 42 is obtained. In a preferred embodiment, the solid/liquid separation step comprises a thickening step. The thickener underflow it directed to a filtration step. The filtrate is combined with the overflow stream and the recovered solids are directed to disposal.

The purified solution 42 is passed to dilution step in which it is contacted with purified water to reduce the lithium concentration. As discussed previously, the inventors have found that the lithium concentration in the purified solution should be maintained above 1.1 wt % in order to recover a high purity lithium product from the solution. In the embodiment shown in FIG. 2, the intermediate solution 24 is concentrated to increase the lithium concentration. This results in a purified solution 42 with a lithium concentration well above the minimum required. The dilution step will decrease the lithium concentration, along with the concentration of any remaining impurities in the solution. By controlling the amount of water added in the dilution step, the concentration of these impurities can be lowered as much as possible, whilst ensuring the lithium concentration above 1.1 wt %. The low impurity concentration will increase the purity of the lithium product that is subsequently recovered.

Following the dilution step, the purified solution 42 is passed to lithium recovery step 44. In the embodiment shown in FIG. 2, the lithium recovery step 44 comprises the crystallisation of lithium carbonate. In order to crystallise lithium carbonate, the purified solution 42 is heated to between 80-85° C. The purified solution 42 is then contacted with sodium carbonate 46 to precipitate lithium carbonate.

In a preferred embodiment of the present invention, the dosage of sodium carbonate 46 is based on the concentration of Li+ in the purified solution 42. In one embodiment, sodium carbonate 38 is added to the solution to target an approximate 1:1 stoichiometric relationship between Li+ and Na₂CO₃.

The resulting slurry is then passed to a solid/liquid separation step in order to recover lithium carbonate 48. The recovered product is washed to reduce the occlusion of impurities such as NaCl and KCl.

### Example 1

A series of tests were performed to determine the impact of sulfate concentration on the recovery of lithium through the evaporation ponds. To better understand the precipitation of KLiSO₄ during evaporation, it was first necessary to understand the (apparent) link between sulfate concentration and on-set of precipitation of KLiSO₄.

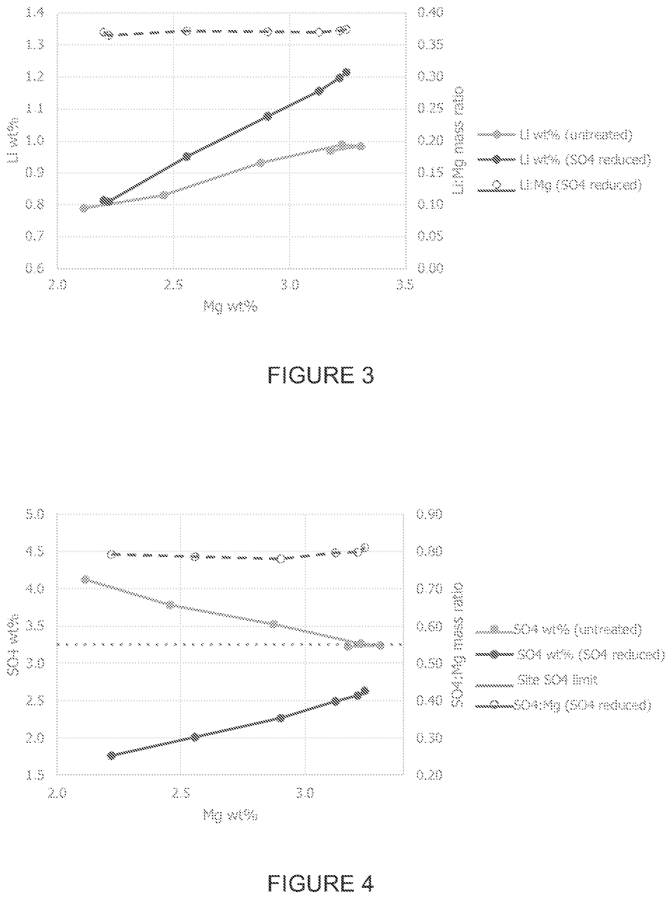

This was conducted with two (2) evaporation profile tests using real brine that had been evaporated to a concentration of 0.8 wt % Li. The tests were performed in parallel at small scale (˜100 mL). In one test the feed was slightly diluted (<15%, ‘Untreated’) and in the other a small aliquot of concentrated CaCl₂ solution (78 g/L Ca) was added to reduce the sulfate by ˜60% (‘Sulfate-Reduced’). Both brines were then evaporated under atmospheric conditions over 8 d at ˜20° C. The concentration paths for lithium and sulfate are presented in FIG. 3 and FIG. 4, respectively.

The data in FIG. 3 shows the substantial difference in the lithium concentration paths for the two evaporation tests. For the sulfate-reduced brine no significant change in the Li:Mg ratio was observed and the brine was able to be evaporated to the target 1.2 wt % Li without precipitation of KLiSO₄ as judged by elemental analysis of the precipitated solids. For the untreated brine, KLiSO₄ precipitation occurred from the very beginning of the evaporation process as indicated by the early divergence of the lithium concentration paths. A final lithium concentration of only 1.0 wt % was achieved in this test indicating ˜20% of the lithium had precipitated during evaporation.

The data in FIG. 4 shows that the precipitation of lithium from the untreated brine was accompanied by the precipitation of sulfate. The mole ratio of Li:SO₄ precipitated was approximately 1:1 throughout the evaporation profile, which is consistent with the precipitation of KLiSO₄. In contrast, no sulfate precipitated from the sulfate-reduced brine as indicated from the constant SO₄:Mg ratio maintained during evaporation.

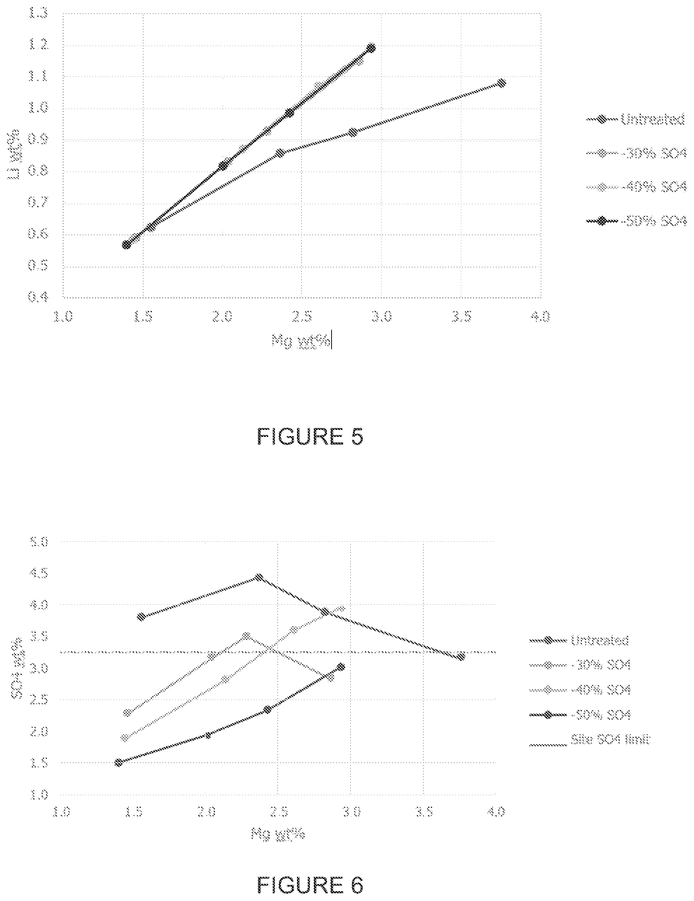

Additional evaporation tests were performed with a generic brine to better define the impact of sulfate concentration. These evaporation tests were performed under reduced pressure in a rotary evaporator over several hours at 25° C.— the temperature employed during the BV evaporation test. Evaporation of the untreated brine was compared to evaporation of brine that had 30, 40 and 50% of its sulfate removed by addition of concentrated CaCl₂ solution. The concentration paths for Li and SO₄ are presented in FIG. 5 and FIG. 6, respectively.

The data in FIG. 5 shows that each of the sulfate-reduced generic brines were able to be evaporated to the target ˜1.2 wt % Li without precipitation of lithium. In contrast, the untreated brine was observed to lose ˜28% of lithium when evaporated to 1.1 wt % Li.

For the generic brines, only the brine where ˜30% of the sulfate was removed prior to evaporation showed any further reduction in sulfate during evaporation (FIG. 6). As this was not due to KLiSO₄, it is suggested that this was due to the precipitation of K2SO₄. It is possible that the (relatively) accelerated evaporation rate used in these tests may have had an impact on the competing precipitation of KLiSO₄ versus K2SO₄.

### Example 2

To determine what impact temperature has on the precipitation of KLiSO₄, a generic brine representative of brine evaporated to ˜0.6 wt % Li prior to precipitation of KLiSO₄ was evaporated at 15, 25 and 35° C. to a target of ˜1.1 wt % Li.

These evaporation tests were performed with strict control of the brine temperature using a thermostat controlled water bath and using a rotary evaporator at reduced pressure. Evaporations were typically performed over 20 h or as required.

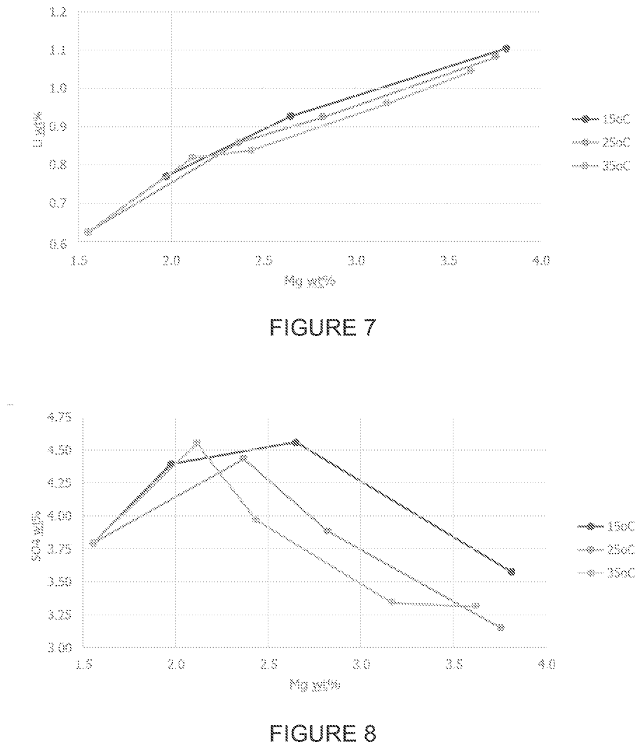

The concentration paths for Li and SO₄ are presented in FIG. 7 and FIG. 8, respectively.

The data in FIG. 7 shows only a minor difference in the lithium concentration paths between the three evaporation temperatures. However, the data does suggest that a greater concentration of lithium can be maintained at lower temperature for a given Mg wt % (evaporation level). A similar trend was also reflected in the sulfate concentration paths shown in FIG. 8.

For each of the temperatures, where precipitation of lithium was identified, the mole ratio of the precipitated lithium and sulfate was 1:1 Li:SO₄, consistent with the precipitation of KLiSO₄. These results indicate that KLiSO₄ is less soluble at higher temperatures and so more likely to precipitate as the temperature of evaporation increases.

### Example 3

A series of tests were performed to characterise the deportment of magnesium, calcium, boron and sulfate during liming at 0.7 wt % Li.

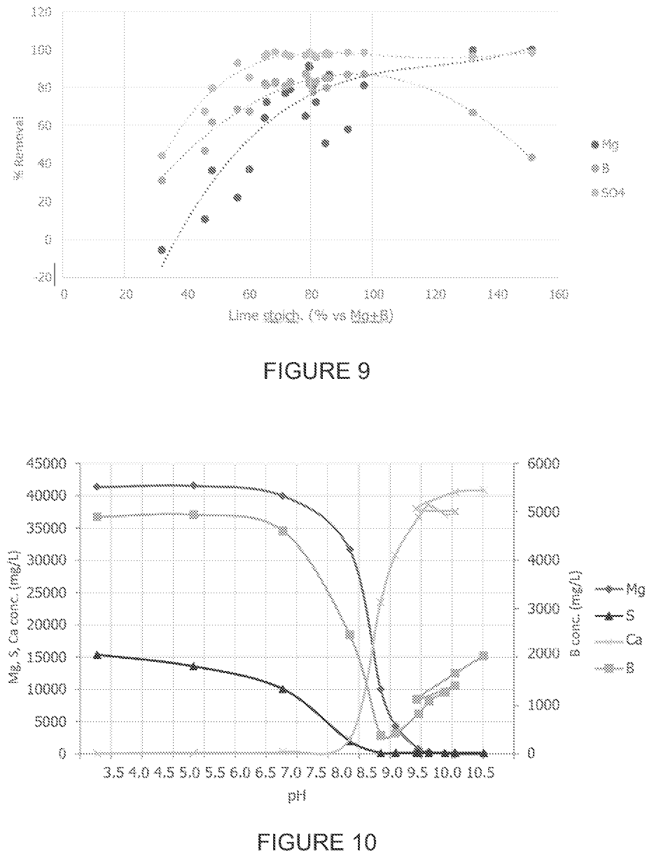

The data in FIG. 9 shows the percentage removal of magnesium, boron and sulfate versus the stoichiometry of lime addition calculated relative to Mg and B. Lime stoichiometry in this case was calculated based on the titrated alkalinity of the lime which was only 22 mmol/g (i.e. 83% of the alkalinity expected for pure Ca(OH)₂).

The first feature of this data to note is that in order to achieve almost complete removal of magnesium (>99%), this required an excess of lime (130-150%). This demonstrates that the utility of the added lime is relatively low, possibly due to passivation of the lime particle surface with gypsum. It would be reasonable to expect improved utility in a continuous operation.

The second feature of this data to note is that the removal of boron was maximised at about 85% stoichiometric addition of lime, which translated to −70-80% magnesium removal. With increased addition of lime, the removal of boron was actually reduced from 85 to ˜65% and even 40% at the maximum addition of lime investigated.

In order to provide further insight into the change in brine chemistry during lime addition, a profile was taken of a test where 151% lime stoichiometry (vs Mg&B) was employed with the concentration of the major elements plotted against pH in FIG. 10.

For boron the concentration path was unusual displaying a ‘U-shaped’ profile centred pH 8.5. Boron initially decreased between pH 7.0-8.5 then increased above pH 8.5. This behaviour shows that the boron species that initially precipitates reacts with the lime as more is added. This behaviour also explains the data at pH 9.5 which is the result of returning solids removed with the thief sub-samples back to the reaction tank. This resulted in a sharp decrease in pH and consequently boron concentration. To return the pH of the reaction back to pH 9.5 required additional lime, which consequently increased the concentration of calcium in solution.

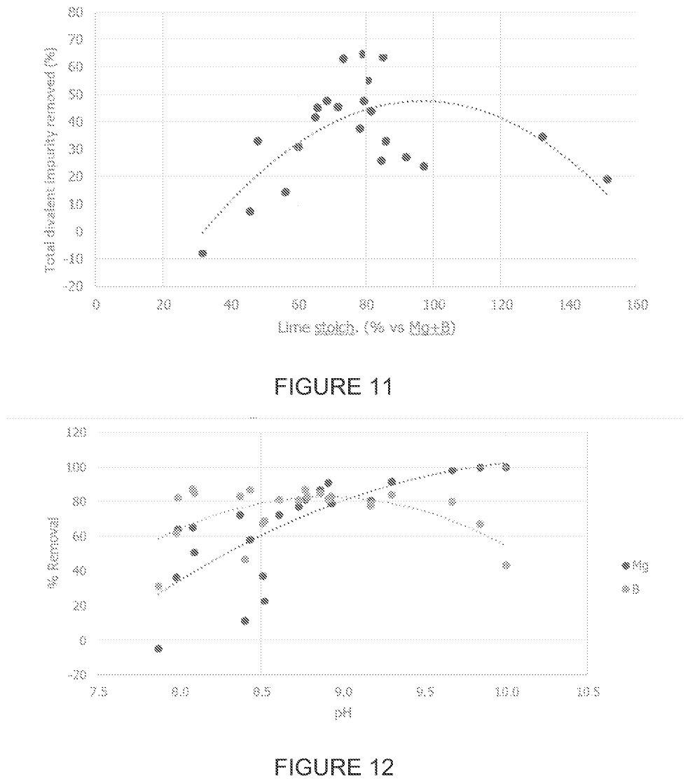

The consequence of pursuing very high (>99%) removal of magnesium using lime is therefore threefold. First, the boron removal is decreased as continued reactivity between the precipitated borate solids and lime at pH >8.5 solubilises the boron. Second, this reaction consumes lime without furthering impurity removal effectively decreasing the utility of the lime. And third, this reaction releases calcium to the brine beyond what is required to remove only magnesium, which effectively increases the divalent ion concentration of the brine (i.e. Ca plus Mg), as shown (FIG. 11). This added divalent load will result in higher reagent consumption and also higher solids production in Softening which adversely impacts the efficiency of the process.

### Example 4

An investigation was made into the effect of pH on magnesium removal. The data in FIG. 12 shows the removal of magnesium and boron versus pH observed with lime addition, but only for the pH range 7.5-10. The data shows that in order to achieve almost complete magnesium rejection (>99%) a pH of ˜10 is required, however, boron removal decreases to only ˜40%. The lack of spread of data in this high pH region suggests that the relationship is strong.

In contrast, in the lower pH range of 8.0-8.5, the correlation between magnesium and boron removal (at a given pH) was particularly poor. For example, at pH 8.5 where ˜80% boron removal occurs, the removal of magnesium varied between 20-80%. Although reproducibility of the degree of magnesium removal was observed to be relatively consistent with a single brine feed, these data demonstrate that changes to the brine composition have a profound impact. Moreover, this shows that caution must be taken when relying on pH to control the performance of the Liming stage.

It is suggested that the lime stoichiometry (mass/volumetric flow ratios) is a more reliable control strategy for this step. However, as a practical guide, a general operating range between pH 8.2-8.8 is recommended to achieve an optimal level of boron removal (˜75-85%) and minimise the divalent ion concentration reporting to Softening.

### Example 5

A total of eight (8) Softening tests were performed using a combination of both caustic and sodium carbonate to remove calcium and magnesium prior to lithium carbonate precipitation. Specific attention was given to determining what magnesium removal in Liming resulted in the best performance in Softening, particularly with respect to lithium losses.

In each test, caustic was added first targeting magnesium removal at about pH 10, then sodium carbonate was added to the resultant slurry relative to the concentration of (soluble) calcium. The results of these tests are summarised in Table 1.

TABLE 1
Summary of Softening Test Work—Caustic and Sodium Carbonate

| Run # | 8 | 9 | 10 | 11 | 12 | 13A | 13B | 13C |
|---|---|---|---|---|---|---|---|---|
| Exp. ID | 8-3 | 9-3 | 10-3 | 11-2 | 12-2 | 13-3A | 13-3B | 13-3C |
| Brine | Site-0.7 | Site-0.7 | Site-0.7 | Site-1.0 | Site-1.0 | Site-0.7 | | |
| Mg removed in | 72 | 64 | 36 | 51 | 22 | 65 | | |
| Liming (%) | | | | | | | | |
| Element | Feed conc. to softening (mg/L) | | | | | | | |
| B | 1444 | 1321 | 3206 | 601 | 1232 | 733 | | |
| Ca | 25785 | 17310 | 678 | 12908 | 3893 | 16705 | | |
| K | 35892 | 38314 | 33058 | 24292 | 23932 | 39496 | | |
| Li | 16766 | 14868 | 16742 | 9800 | 10711 | 12864 | | |
| Mg | 13791 | 17772 | 34609 | 15623 | 24328 | 13276 | | |
| Na | 25832 | 30826 | 23242 | 15663 | 17085 | 35758 | | |
| S | 111 | 279 | 2776 | 272 | 767 | 138 | | |
| Element | Softening PF conc. (mg/L) | | | | | | | |
| B | 870 | 898 | 1084 | 89 | 400 | 148 | 125 | 347 |
| Ca | 8 | 7 | 21 | 5 | 6 | 23 | 19 | 55 |
| K | 27814 | 30636 | 27725 | 14751 | 24231 | 29025 | 28679 | 29933 |
| Li | 11418 | 10217 | 13548 | 6068 | 9685 | 9537 | 9697 | 9274 |
| Mg | <1 | <1 | <1 | 7 | <1 | 15 | 23 | 118 |
| Na | 68652 | 69792 | 72981 | 36911 | 61108 | 61370 | 60841 | 61576 |
| S | 49 | 149 | 2107 | 52 | 548 | 19 | 21 | 78 |
| Element | Removal from feed (%, by K tie) | | | | | | | |
| B | 22 | 15 | 60 | 76 | 68 | 72 | 77 | 38 |
| Ca | 100 | 100 | 96 | 100 | 100 | 100 | 100 | 100 |
| Li | 12 | 14 | 8^{a} | −2 | 11 | −1 | −4 | 5 |
| Mg | 100 | 100 | 100 | 100 | 100 | 100 | 100 | 99 |
| Insoluble Li after | 3 | 4 | 8 | 1 | 3 | na | na | na |
| wash (%) | | | | | | | | |
| Total wash ratio | 17 | 10 | 13 | 23 | 16 | 0 | 0 | 0 |
| (L/Kg) | | | | | | | | |
| NaOH stoich. | 122 | 110 | 118 | 102 | 105 | 105 | 105 | 106 |
| (% vs Mg) | | | | | | | | |
| SC stoich. | 116 | 119 | 120 | 116 | 119 | 115 | 115 | 115 |
| (% vs Ca) | | | | | | | | |
| pH | 9.8 | 10.0 | 9.9 | 10.0 | 10.0 | 9.6 | 9.6 | 10.7 |
| (post-NaOH) | | | | | | | | |
| pH | 11.3 | 11.3 | 10.4 | 10.1 | 10.6 | 9.4 | 9.9 | 7.7 |
| (post-SC) | | | | | | | | |
| Reaction temp. | 40 | 40 | 40 | 40 | 40 | 40 | 20 | 20 |
| (° C.) | | | | | | | | |
| Reaction time | 2 | 2 | 2 | 2 | 2 | 4 | 4 | 3 |
| (h) | | | | | | | | |

^{a}Run 10: Li removal from feed underestimated by K tie; calculated from mass balance in washates and cake

For Runs 8, 9 and 10, Liming was conducted at 0.7 wt % Li, targeting a high (˜26 g/L), medium (˜17 g/L) and low (˜0.7 g/L) residual calcium concentration, respectively. For Runs 11 and 12 the brine Liming was conducted at 1.0 wt % Li targeting a high (˜13 g/L) and low (˜4 g/L) residual calcium concentration, respectively. Finally, Runs 13A-C were conducted based on the results of the Runs 8-12 in an attempt to optimise the softening conditions using the preferred liming conditions.

In each of the Run 8, 9, 10 and 12 tests, a significant amount of lithium precipitation was observed (8-14%), but the losses of lithium following washing were typically ˜3%. Surprisingly, the degree of precipitation of lithium during Softening did not appear to correlate to the concentration of calcium in the feed liquor as expected. No obvious issue with the experimental execution was noted in these tests.

Run 11 was unusual in that it resulted in no precipitation of lithium from solution. Two features were unique about Run 11 which may have resulted in the anomalously low lithium precipitation. Firstly, the lithium concentration in the feed to Softening was significantly less than each other run (˜6 g/L Li), and secondly, the final reaction pH was somewhat lower (at least ˜0.3 pH units) than the other runs. The low reaction pH was due to the low NaOH stoichiometry required to achieve the pH 10 target for magnesium precipitation.

The exact reason for the lack of losses of lithium in Run 11 remains unclear. However, it is suspected that the reduced lithium concentration is the most likely reason. As the precipitation of LC is in fact a reactive crystallisation process it is suspected that the reduced concentration results in a slower rate of crystallisation of LC than with a much greater concentration viz.˜>10 g/L Li as in other runs.

The importance of crystallisation conditions has been noted previously during LC precipitation test work and it seems reasonable to expect that similar effects might be at play here although this step is targeting calcium precipitation.

The Liming conditions selected for Runs 13A-C were essentially the same as those used for Run 9; i.e. Liming at 0.7 wt % Li to target ˜65% magnesium removal. Liming at 0.7 wt % Li was undertaken as better lime reactivity is obtained with less concentrated brine, and both Liming and Softening following evaporation results in some dilution, and this in turn reduces the stage efficiency and reliance on LC barrens to limit losses of lithium.

Liming to target ˜65% magnesium removal was set in order to achieve the best lime utility with respect to magnesium and boron removal. Targeting much more or less magnesium removal increases the divalent load to the softening stages and reduces boron removal.

Following liming, the brine was evaporated to ˜1.1 wt % Li. During Softening the caustic addition was reduced slightly compared to previous tests, and a stoichiometric amount (105%) added relative to the magnesium present, rather than addition to achieve pH 10 target. A similar sodium carbonate addition was used compared to previous tests.

In Run 13A the reaction was performed at 40° C. and in Run 13B the reaction was performed at 20° C. No difference in reaction performance with temperature was observed and both tests resulted in effectively no lithium precipitation. The final reaction pH of these tests was also relatively low; pH 9.4 (Run 13A) and pH 9.9 (Run 13B). Despite the lower pH very high magnesium removal was still obtained in these tests (<23 mg/L). In Run 13C the reaction temperature was also 20° C. but the reagent addition was swapped so that sodium carbonate was added first followed by NaOH. This resulted in 5% lithium precipitation and a higher reaction pH of 10.7.

### Example 6

Precipitation of lithium carbonate (LC) was undertaken using the resultant liquors from the combined caustic/sodium carbonate divalent removal tests where a high degree of magnesium and calcium were achieved. These were liquors from Runs 8-12 and 13B described in Example 5. A summary of the composition of the LC produced is presented in Table 2.

TABLE 2
Summary of LC Precipitation Test Work

| Run # | 8 | 9 | 10 | 11 | 12 | 13B |
|---|---|---|---|---|---|---|
| Exp. ID | 8-4 | 9-4 | 10-4 | 11-3 | 12-3 | 13B-4 |
| Brine | Site-0.7 | Site-0.7 | Site-0.7 | Site-1.0 | Site-1.0 | Site-0.7 |
| Mg removed in | 72 | 64 | 36 | 51 | 22 | 65 |
| Liming (%) | | | | | | |
| Element | Feed conc. to LC crystallisation (mg/L) | | | | | |
| B | 870 | 898 | 1084 | 89 | 400 | 125 |
| Ca | 8 | 7 | 21 | 5 | 6 | 19 |
| K | 27814 | 30636 | 27725 | 14751 | 24231 | 28679 |
| LI | 11418 | 10217 | 13548 | 6068 | 9685 | 9697 |
| Mg | <1 | <1 | <1 | 7 | <1 | 23 |
| Na | 68652 | 69792 | 72981 | 36911 | 61108 | 60841 |
| S | 49 | 149 | 2107 | 52 | 548 | 21 |
| Element | LC impurity conc. (ppm) | | | | | |
| B | 124 | 66 | 78 | <27 | 44 | 43 |
| Ca | 543 | 270 | 345 | 526 | 185 | 224 |
| K | 699 | 828 | 513 | 145 | 724 | 813 |
| Mg | 178 | 40 | 157 | 693 | 107 | 518 |
| Na | 3068 | 2608 | 1626 | 584 | 2033 | 1133 |
| S | <25 | <32 | 118 | 28 | 67 | <24 |
| Cl | 2624 | 2667 | 374 | 82 | 948 | 1297 |
| LC purity (%) | 99.0 | 99.1 | 99.4 | 99.5 | 99.3 | 99.3 |
| Li recovery (%) | 86 | 77 | 79 | 61 | 71 | 72 |

For Runs 8-12 and 13B an LC purity >99% was achieved for all tests. The best result was obtained by Run 11 with 99.5% purity and exceptionally low potassium, sodium and chloride impurity. Run 11 was limed at 1.0 wt % Li and dilution introduced by liming followed by more dilution introduced by softening resulted in a very low lithium concentration in the feed to LC precipitation (˜6 g/L). This may have led to slower, more uniform crystal growth and consequently less NaCl and KCl occlusion with the LC. This result highlights the high degree of NaCl and KCl rejection that can be obtained in LC precipitation under favourable crystallisation conditions.

Due to the very low lithium concentration in the feed to LC precipitation (˜6 g/L), Run 11 also resulted in the lowest lithium recovery to LC (61%). In comparison, where liming was performed at 0.7 wt % Li followed by evaporation to >1.1 wt % Li, much higher lithium concentrations in the feed to LC precipitation were present (˜9-14 g/L) and much higher lithium recoveries were obtained (72-86%). This result highlights another disadvantage to Liming at the conclusion of evaporation, in that the additional dilution introduced by liming substantially reduces the recovery of LC.

The worst LC purity of 99.0% and 99.1% was produced from Runs 8 and 9, respectively, predominantly due to a higher NaCl content. The feed solutions for these tests had a higher pH (11.3) compared to the other Runs (pH 9.9-10.6) which may have resulted in more rapid LC crystallisation, irregular crystal growth and more NaCl occlusion.

Sodium, potassium and chloride are major impurities in each of the LC samples, which is as expected for LC precipitation from mixed Na/K chloride brine feed liquors. In general the chloride impurity present in the LC correlates well with the amount of sodium plus potassium impurity present, suggesting that these impurities do indeed occur due to occlusion of NaCl and KCl in the LC crystal. Importantly, occluded salts are not easily ‘washed’ from the LC. Note, LC crystallisation is known to improve under continuous process operation, with seed recycle, extended operation time, optimal reactor design etc, conditions which are not easily replicated in bench scale, batch test work.

Although each of the feed liquors contained relatively low concentrations of calcium and magnesium, as the associated carbonates are extremely insoluble and they report to the resultant LC, both calcium and magnesium appeared as major impurities in each of the LC produced. Based on the Impurity Removal and Softening test work results, increased rejection of calcium and magnesium from the resultant LC would require treatment via ion exchange (IX) prior to LC precipitation.

The deportment of boron to the resultant LC was somewhat variable and did not appear to be correlated with the composition of the various feed liquors. That being said, the majority of boron does not report to the resultant LC in accord with the behaviour observed in the previous process development program.

The presence of sulfate impurity in LC has not previously been a concern in the process development work performed to date. Lime addition has typically been sufficient to produce very low sulfate concentrations in the brine. However, in Run 10 a low lime addition was used for impurity removal and an elevated sulfate concentration carried through to LC precipitation which resulted in elevated sulfate impurity in the LC, i.e. 118 ppm S compared to <25 ppm S where liming achieved much higher sulfate removal (e.g. Runs 8 and 13B).

### Example 7

Softening tests were repeated on solutions in which the lithium concentration was increased to both 1.7 wt % Li and 2.1 wt % Li following the liming stage. Similar to Example 5, these tests were conducted using a combination of both caustic and sodium carbonate to remove calcium and magnesium prior to lithium carbonate precipitation.

In each test, caustic was added first targeting magnesium removal at about pH 10, then sodium carbonate was added to the resultant slurry relative to the concentration of (soluble) calcium. The results of these tests are summarised in Table 3 and 4 for 1.7 wt % and 2.1% respectively:

TABLE 3
Softening test on 1.7 wt % Li solution
Feed liquor = GA-LCP-7(A-C)

| Caustic addition conditions | | Softening conditions | | Filtration and Wash Conditions | |
|---|---|---|---|---|---|
| 32% NaOH conc. (wt %)= | 32 | SC conc. (g/100 g)= | 20 | Final slurry mass (g)= | 5226 |
| 32% NaOH added (g)= | 1085 | SC solution added (g)= | 556 | Wash type= | 3x repulp |
| NaOH addition (g/L feed)= | 119 | SC addn (g/L feed)= | 39 | Washate= | DI water |
| NaOH stoich. (% vs Mg)= | 102 | SC stoich. (% vs Ca)= | 117 | Wash ratio (L/Kg dry cake)= | 16 |
| Reaction temp. (° C.)= | 20 | Reaction temp. (° C.)= | 20 | Wet cake mass (g)= | 1175 |
| Reaction time (h)= | 0.5 | Reaction time (h)= | 4.0 | Dry cake mass (g)= | 401 |
| | | | | Final cake moisture (wt %)= | 66 |
| | | | | Slurry density (wt %)= | 8 |

| Liquor= | Feed | PF | Repulp 1 | Repulp 2 | Repulp 3 | Cake digest |
|---|---|---|---|---|---|---|
| Reaction time (h)= | 0 | 4.5 | | | | |
| SC soln. added (g)= | | 556 | | | | |
| Mass (g)= | 3602 | 2692 | 2211 | 1940 | 2376 | 2.08 |
| Volume (L)= | 2.89 | 2.30 | 2.04 | 1.86 | 2.32 | 0.05 |
| SG= | 1.25 | 1.17 | 1.08 | 1.04 | 1.02 | |
| pH= | | 10.0 | | | | |
| | Liquors | | | | | |
| | Feed | PF | Repulp 1 | Repulp 2 | Repulp 3 | Cake digest |
| Element | (mg/L) | | | | | |
| B | 1895 | 591 | 263 | 156 | 106 | 301 |
| Ca | 12434 | 13 | 5 | 8 | 16 | 3721 |
| K | 21582 | 14893 | 7062 | 3043 | 1506 | 190 |
| Li | 21325 | 14500 | 6208 | 2863 | 1425 | 310 |
| Mg | 35489 | 5 | 27 | 47 | 73 | 10211 |
| Na | 9579 | 62681 | 29695 | 12569 | 5721 | 793 |
| S | 161 | 87 | 57 | 29 | 14 | 22 |
| Sr | 39 | 1 | 1 | 1 | 1 | 10 |
| | Reportable | | | | | |
| | PF | Repulp 1 | Repulp 2 | Repulp 3 | Cake | Acc. |
| Element | Recovered (%) | | | | | (%) |
| B | 25 | 10 | 5 | 5 | 53 | 97 |
| Ca | 0 | 0 | 0 | 0 | 100 | 100 |
| K | 55 | 23 | 9 | 6 | 3 | 96 |
| Li | 54 | 21 | 9 | 5 | 5 | 94 |
| Mg | 0.0 | 0.1 | 0.1 | 0.2 | 96 | 96 |
| Na | — | — | — | — | — | — |
| S | 43 | 25 | 12 | 7 | 45 | 131 |
| Sr | 2 | 2 | 2 | 2 | 84 | 92 |

TABLE 4
Softening test on 2.1 wt % Li solution
Feed liquor = LCP-1B-3 to 9

| Caustic addition conditions | | Softening conditions | | Filtration and Wash Conditions | |
|---|---|---|---|---|---|
| 32% NaOH conc. (wt %)= | 31 | SC conc. (g/100 g)= | 20 | Final slurry mass (g)= | 6117 |
| 32% NaOH added (g)= | 1124 | SC solution added (g)= | 1116 | Wash type= | 3x repulp |
| NaOH addition (g/L feed)= | 125 | SC addn (g/L feed)= | 79 | Washate= | DI water |
| NaOH stoich. (% vs Mg)= | 114 | SC stoich. (% vs Ca)= | 112 | Wash ratio (L/Kg dry cake)= | 5.4 |
| Reaction temp. (° C.)= | 20 | Reaction temp. (° C.)= | 20 | Wet cake mass (g)= | 1226 |
| Reaction time (h)= | 0.5 | Reaction time (h)= | 4.0 | Dry cake mass (g)= | 413 |
| | | | | Final cake moisture (wt %)= | 66 |
| | | | | Slurry density (wt %)= | 7 |

| Liquor = | Feed | PF | Repulp 1 | Repulp 2 | Repulp 3 | Cake digest |
|---|---|---|---|---|---|---|
| Reaction time (h) = | 0 | 4.5 | | | | |
| SC soln. added (g) = | | 1116 | | | | |
| Mass (g) = | 3580 | 4029 | 1117 | 710 | 576 | 2.02 |
| Volume (L) = | 2.81 | 3.42 | 1.02 | 0.67 | 0.55 | 0.05 |
| SG = | 1.27 | 1.18 | 1.10 | 1.07 | 1.04 | |
| pH = | | 10.0 | | | | |
| | Liquors | | | | | |
| | Feed | PF | Repulp 1 | Repulp 2 | Repulp 3 | Cake digest |
| Element | (mg/L) | | | | | |
| B | 1736 | 1029 | 545 | 269 | 86 | 47 |
| Ca | 26687 | 20 | 2 | 1 | 1 | 6484 |
| K | 18806 | 11474 | 6150 | 3145 | 1641 | 153 |
| Li | 26563 | 15257 | 8391 | 4814 | 3336 | 326 |
| Mg | 33332 | 8 | 1 | 1 | 44 | 7974 |
| Na | 5739 | 63292 | 32337 | 16434 | 8962 | 789 |
| S | 76 | 33 | 24 | 27 | 15 | 5 |
| Sr | 17 | 1 | 1 | 1 | 1 | 3 |
| | Reportable | | | | | |
| | PF | Repulp 1 | Repulp 2 | Repulp 3 | Cake | Acc. |
| Element | Recovered (%) | | | | | (%) |
| B | 72 | 11 | 4 | 1 | 10 | 98 |
| Ca | 0 | 0 | 0 | 0 | 89 | 89 |
| K | 74 | 12 | 4 | 2 | 3 | 95 |
| Li | 70 | 11 | 4 | 2 | 4 | 93 |
| Mg | 0 | 0 | 0 | 0 | 87 | 87 |
| Na | — | — | — | — | — | — |
| S | 53 | 12 | 8 | 4 | 23 | 99 |
| Sr | 7 | 2 | 1 | 1 | 69 | 81 |

For the 1.7 wt % solution, the ration of Li:K increased from 0.99 to 1.63. For the 2.1 wt % solution, the ratio of Li:K increased from 1.41 to 2.13. This demonstrates that increasing the concentration of lithium in the second concentration step may be used to increase the ration of lithium to potassium in the purified solution.

It will be appreciated by those skilled in the art that variations and modifications to the invention described herein will be apparent without departing from the spirit and scope thereof. The variations and modifications as would be apparent to persons skilled in the art are deemed to fall within the broad scope and ambit of the invention as herein set forth.

1. A method for the recovery of lithium products from an aqueous solution, the method comprising the steps of:
i. contacting the solution with an alkaline material to precipitate a target amount of magnesium in the brine solution and separating the precipitated solids from an intermediate solution;
ii. contacting the intermediate solution with a controlled amount of a hydroxide salt to precipitate magnesium in the intermediate solution;
iii. contacting the intermediate solution with a controlled amount of sodium carbonate to precipitate impurities and separating the precipitated solids from a purified solution; and
iv. recovering lithium products from the purified solution.

2. A method according to claim 1, wherein the aqueous solution is subjected to a concentration step prior to step (i).

3. A method according to claim 2, wherein the concentration step will increase the concentration of lithium in the aqueous solution to 0.1-1.2%.

4. A method according to claim 1, wherein the alkaline material comprises calcium hydroxide.

5. A method according to claim 1, wherein step (i) precipitates 50-80% of the magnesium in the aqueous solution.

6. A method according to claim 1, wherein step (i) precipitates 63-83% of the boron in the aqueous solution.

7. A method according to claim 1, wherein the aqueous solution is maintained at a pH of 9 or below during step (i).

8. A method according to claim 1, wherein the intermediate solution is directed to a secondary concentration step prior to step (ii).

9. A method according to claim 8, wherein the secondary concentration step will increase the concentration of lithium in the aqueous solution to at least 1.2%.

10. A method according to claim 9, wherein the secondary concentration step will increase the concentration of lithium in the aqueous solution to between 1.2%-2.2%.

11. A method according to claim 8, wherein the secondary concentration step will increase the concentration of lithium in the aqueous solution to at least 1.6%.

12. A method according to claim 1, wherein the hydroxide salt is sodium hydroxide.

13. A method according to claim 1, wherein the amount of hydroxide salt added in step (ii) targets a 1.25:1-1:1.25 stoichiometric concentration of Mg²⁺:OH⁻.

14. A method according to claim 1, wherein the solution pH is maintained below 10 during step (ii).

15. A method according to claim 1, wherein the amount of sodium carbonate added in step (iii) targets a 1.25:1-1:1.25 stoichiometric concentration of Ca²⁺:Na₂CO₃.

16. A method according to claim 11, wherein the method further comprises subjecting the purified solution to a dilution step prior to the step of recovering lithium products from the purified solution.

17. A method according to claim 1, wherein lithium carbonate is recovered from the purified solution.

18. A method according to claim 17, wherein sodium carbonate is added to the purified solution to precipitate lithium chloride.

19. A method according to claim 18, wherein the amount of sodium carbonate added to the purified solution targets a 1.25:1-1:1.25 stoichiometric concentration of Li²⁺:Na₂CO₃.

20. A method according to claim 1, wherein lithium hydroxide is recovered from the purified solution.

21. A method according to claim 1, wherein the recovered lithium product is subjected to a purification step.
